(19) United States
(12) Patent Application Publication
(10) Pub. No.: US 2023/0217946 A1
(43) Pub. Date: Jul. 13, 2023

(54) STABILIZATION OF LC-PUFAS BY SIDE STREAM PRODUCT FROM GREEN COFFEE DECAFFEINATION

(71) Applicant: SOCIETE DES PRODUITS NESTLE S.A., Vevey (CH)

(72) Inventors: ZHEN ROHFRITSCH, Blonay (CH); RACHID BEL-RHLID, Savigny (CH)

(21) Appl. No.: 18/001,512

(22) PCT Filed: Jun. 16, 2021
(86) PCT No.: PCT/EP2021/066173

§ 371 Date: Dec. 12, 2022

(30) Foreign Application Priority Data
Jun. 17, 2020 (EP) 20180414.3

(51) Int. Cl. A23D 9/06; A23D 9/007; A23F 5/26; A23L 33/12; A23L 33/105; C11B 5/00

(52) U.S. Cl. CPC A23D 9/06; A23D 9/007; A23F 5/26; A23L 33/12; A23L 33/105; C11B 5/0085

(57) ABSTRACT

The present invention relates generally to the field of the LC-PUFA containing compositions. For example, the present invention relates to at least partially preventing, inhibiting, reducing and/or stopping the oxidation of LC-PUFA in a composition. An embodiment of the present invention relates to a composition comprising at least one LC-PUFA containing oil and green coffee extract. The composition may contain at least 0.01 weight-% LC-PUFA. Another embodiment of the present invention relates to the use of green coffee extract in compositions comprising an LC-PUFA containing oil to at least partially prevent, reduce, inhibit and/or stop the oxidation of LC-PUFA in a composition.

### FIELD OF THE INVENTION

The present invention relates generally to the field of the LC-PUFA containing compositions. For example, the present invention relates to at least partially preventing, inhibiting, reducing and/or stopping the oxidation of LC-PUFA in a composition. An embodiment of the present invention relates to a composition comprising at least one LC-PUFA containing oil and green coffee extract. The composition may contain at least 0.01 weight-% LC-PUFA. Another embodiment of the present invention relates to the use of green coffee extract in compositions comprising an LC-PUFA containing oil to at least partially prevent, reduce, inhibit and/or stop the oxidation of LC-PUFA in a composition.

### BACKGROUND OF THE INVENTION

The importance of long chain polyunsaturated fatty acids (LC-PUFA) in the diet of humans, and particularly infants, is now well established (see e.g., WO 96/40106). Typical dietary sources of LC-PUFA are organ meats, fish, eggs and human breast milk. However, present day diets are frequently deficient in LC-PUFA, resulting in a need to supplement the diet with a source of LC-PUFA.

Sources of LC-PUFA supplements include egg yolk phospholipids, and triglyceride oils extracted from fish and marine microorganisms. The use of egg yolk phospholipids and/or marine triglyceride oils to supply LC-PUFA in infant formula is taught, e.g., in U.S. Pat. No. 4,670,285 and in WO 96/10922. The use of microbial triglyceride oils to supply LC-PUFA in infant formula is taught in U.S. Pat. Nos. 5,374,657, 5,397,591 and 5,550,156. Another source to supply LC-PUFA in infant formula is a lipid extract from human placenta, taught in European Patent EP 0 140 805.

Because of their degree of unsaturation, LC-PUFA are prone to oxidative degradation. Preserving the double bonds of the LC-PUFA through processing and storage is a critical issue in the preparation and distribution of LC-PUFA containing food compositions, such as infant formula, baby food and other foods and nutritional supplements containing such materials.

EP0404058 describes the addition of alpha-tocopherol and/or ascorbylpalmitate as antioxidants during the preparation of LC-PUFA-containing mixtures to reduce oxidative degradation. The LC-PUFA-containing materials are added to a mixture containing antioxidants in amounts to give final concentrations of from 150-300 ppm, and the mixture typically contains mono-and diglyceride emulsifiers. U.S. Pat. No. 5,855,944 describes a process for stabilizing LC-PUFA containing marine oils by treating the oils with silica, steam deodorizing the oil, and then adding to the oil a mixture of food-grade lecithin, alpha-tocopherol, and ascorbyl-palmitate in a total amount of 1000-4000 ppm of the mixture. EP2025237 describes the use of a composition comprising an LC-PUFA containing oil and lecithin, wherein the weight ratio of lecithin to LC-PUFA is at least about 25:75 to prevent, inhibit and/or stop the formation of fishy odors from an LC-PUFA containing oil.

Still, the reduction of the generation of fishy odors caused by oxidation of LC-PUFA containing oils remains an important technical issue to be solved. The inhibition of the very disturbing fishy off-odors in the final food products, are of great importance to the consumer. The formation of ppb amounts of fishy off-flavor compounds is sufficient to produce a strong fishy off-odor, even though the concentration of the precursor LC-PUFAs are not substantially reduced.

It would be desirable, if the prevention, inhibition, reduction and/or stopping of LC-PUFA oxidation was achieved by natural means, in particular by the use of a material from a plant source that has a healthy reputation and tradition.

Hence, there remains a need for an alternative, natural, consumer-friendly, inexpensive, and effective method for the inhibition of formation of fishy off flavors in compositions containing LC-PUFA.

WO 2004/026287 discloses an orally administrable composition for improving skin quality and prevent or restore age-related alterations of skin in humans or animal, said composition comprising fatty acids, such as omega-3 fatty acids, and a coffee extract. The composition is used in food products. Other antioxidants and components such as polyphenolic antioxidant (ginkgo extract), vitamin C, E and further proteins and carbohydrates source, are present. This document however does not suggest that the taught effect could be applicable to human or animal nutrition.

JP 2002 142673 A relates to a food composition comprising oil, selected from vegetable oil or fish oils and antioxidants chosen from vitamin C, citric acid, chlorogenic acid, proanthocyanidin, flavone derivative, tea extract, grape seed extract and rutin and a raw coffee extract. In one example, raw coffee extract and chlorogenic acid are present and used as antioxidant.

WO 2011/002805 A2 teaches a composition for PUFA stabilization using primarily lecithin, and wherein the antioxidative properties of raw coffee extract and chlorogenic acid are also disclosed.

The three prior art references cited above refer to a potential effect of raw coffee extract on the antioxidative effect on long chain polyunsaturated fatty acids. However, the effect was found by the present inventors as still being limited, such that there is still a need for improved stabilization of PUFAs in edible compositions for nutrition of humans or animals. Furthermore, they refer to raw coffee extracts, which require antioxidative material obtained specifically through complex and expensive processes.

Any reference to prior art documents in this specification is not to be considered an admission that such prior art is widely known or forms part of the common general knowledge in the field.

Consequently, it is an objective of the present invention to improve and/or enrich the state of the art and, in particular, to provide the art with a way to prevent, inhibit, reduce or stop the formation of fishy off flavors in compositions comprising LC-PUFA effectively and inexpensively by using a plant-based ingredient with a good reputation, or to at least provide a useful alternative.

### SUMMARY OF THE INVENTION

The inventors were surprised to see that the objective of the present invention could be achieved by the subject matter of the independent claims. The dependent claims further develop the idea of the present invention.

Accordingly, the present invention provides a composition comprising at least one LC-PUFA containing oil and green coffee extract.

Further, the present invention provides a product comprising at least one LC-PUFA containing oil and green coffee extract.

Even further, the present invention provides a use of green coffee extract in compositions comprising an LC-PUFA containing oil to at least partially prevent, reduce, inhibit and/or stop the oxidation of LC-PUFA in a composition.

As used in this specification, the words “comprises”, “comprising”, and similar words, are not to be interpreted in an exclusive or exhaustive sense. In other words, they are intended to mean “including, but not limited to”.

The inventors have shown that green coffee extract can be used to effectively prevent, inhibit, reduce or stop the formation of fishy off flavors in compositions comprising LC-PUFA. Green coffee extract was shown to effectively prevent, inhibit, reduce or stop LC-PUFA oxidation.

Without wishing to be bound by theory, the inventors currently believe that the effect of green coffee extract to prevent the formation of fishy odors from LC-PUFA is due to green coffee extract's antioxidant properties.

Green coffee extract is prepared from green coffee beans or raw coffee beans, in other words, coffee beans that are not roasted. Green coffee bean extract is meanwhile a well-known nutritional supplement often used in weight loss supplements, in supplements to support normal blood pressure and in supplements to support normal cholesterol levels.

Green coffee extract is commercially available from many suppliers.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 shows the antioxidant capacity of crude caffeine in protecting fish oil oxidation in a mixture containing 2 g of refined high DHA LC-PUFA oil and different amounts of crude caffeine, represented by induction period (IP) measured by RapidOxy 100. Refined fish oil is the negative control without additional antioxidants, and NAD and NIF oils are the positive commercial controls containing chemical antioxidants. Error bars indicated SD of the measurements (n=2);

FIG. 2 shows the antioxidant capacity of decaffeinated green coffee extract (DCGE) in protecting fish oil oxidation in a mixture containing 2 g of refined high DHA LC-PUFA oil and different amounts of crude caffeine, represented by induction period (IP) measured by RapidOxy 100. Error bars indicated SD of the measurements (n=2);

FIG. 3 shows the antioxidant capacity of hydrolysed decaffeinated green coffee extract (DCGE) in protecting fish oil oxidation in a mixture containing 2 g of refined high DHA LC-PUFA oil and different amounts of hydrolysed DCGE, represented by induction period (IP) measured by RapidOxy 100. Error bars indicated SD of the measurements (n=2);

FIG. 4 shows the antioxidant capacity of active components in green coffee extracts in protecting fish oil oxidation in a mixture containing 2 g of refined high DHA LC-PUFA oil and different amounts of active components, represented by induction period (IP) measured by RapidOxy 100. Error bars indicated SD of the measurements (n=2).

### DETAILED DESCRIPTION OF THE INVENTION

Consequently, the present invention relates in part to a composition comprising at least one LC-PUFA containing oil and green coffee extract. The composition may be any composition that contains LC-PUFA. The composition may contain LC-PUFA naturally or may be enriched with LC-PUFA. For example, the composition may contain at least 0.01 weight-% LC-PUFA.

Any green coffee extract may be used. Green coffee extract may be obtained from any coffee variety. For example, the coffee variety may be selected from the group consisting of Arabica varieties, Robusta varieties or combinations thereof.

The green coffee extract used for the purpose of the present invention may contain caffeine in the range of about 1-60 weight-% and chlorogenic acids in the range of about 1-40 weight-%.

Green coffee extract can be prepared by any method known in the art. For example, the green coffee extract may be obtained from green coffee beans by a process comprising the steps of combining green coffee beans and water, heating the mixture and collecting the extract.

For example, the green coffee extract may be obtained from green coffee beans by a process comprising the steps of:
combining green coffee beans and water in a weight ratio in the range of about 1:5 to 1:3, for example of about 1:4.5 to 1:3.5, for example of about 1:4;
heating the mixture to a temperature in the range of about 50-100° C., for example of about 60-90° C., or for example of about 70-85° C., for a time period of about 200-400 minutes, or of about 250-350 minutes, of about 280-330 minutes; and
collecting the extract.

Optionally, the green coffee extract may be at least partially dried after its preparation to reduce the water content. In one embodiment of the present invention, the green coffee extract is provided in powder form.

To increase extraction speed, the green coffee beans may be at least partially ground.

For example, the green coffee extract used for the purpose of the present invention may contain caffeine in the range of about 40-60 weight-% and chlorogenic acids in the range of about 20-40 weight-%. The inventors refer to such a green coffee extract as crude caffeine.

A particular preferred crude caffeine can be prepared as follows:

Green coffee beans (1 kg) were submerged in hot water (4 kg) at 85° C. and the mixture was stirred for 5 hours. After filtration, the water phase was dried by freeze-drying, spray-drying, or by rotary evaporation of water to yield crude caffeine.

The green coffee extract used for the purpose of the present invention may also contain caffeine in the range of about 1-10 weight-% and chlorogenic acids in the range of about 30-60 weight-%. The inventors refer to such a green coffee extract as decaffeinated green coffee extract (DGCE).

A particular preferred DGCE can be prepared as follows:

The decaffeination of crude caffeine can be performed by extraction with CH2Cl2. This decaffeinated green coffee extract is commercially available from Chemical Resources (India) or from Testa (Italy). The decaffeination can be performed with other organic solvents (e.g. ethyl acetate) or by entrapment of the caffeine on solid support (e.g. resin, silica, charcoal).

The decaffeination of green beans could also be performed by extraction with supercritical CO2 from green beans. This decaffeinated green coffee extract was purchased from Martin Bauer (Germany).

The green coffee extract used for the purpose of the present invention may also contain caffeine in the range of about 1-10 weight-%, chlorogenic acids in the range of about 1-10 weight-%, caffeic acid in the range of about 5-15% and ferulic acid in the range of about 0.5 to 5%. The inventors refer to such a green coffee extract as hydrolysed decaffeinated green coffee extract (Hydrolysed DGCE).

The hydrolysis of green coffee extract can be performed by hydrolases such as esterases and lipases or any enzymatic preparation containing such enzymatic activity. Esterase from Lactobacillus johnsonii was isolated, characterized and over-expressed in E. coli. Commercially available esterases are for example hog liver esterase (HLE) or pig liver esterase (PLE) both from Sigma-Aldrich or chlorogenate esterase from Kikkoman (Japan). Commercially available enzymatic preparations containing hydrolase activity are for example Aromase (from AMANO) and Rapidase (from DSM).

A particular preferred Hydrolysed DGCE can be prepared as follows:

Decaffeinated green coffee extract (1.76 Kg) was dissolved in water (8.8 Kg) under stirring. The pH was then adjusted to 4.5 by addition of HCl (0.36 Kg). To this solution, 24 g of enzyme (Esterase from L. johnsonii, 2.0 U/mg) was added in two batches: 16 g of enzyme was added at time T=0 h and 8 g of enzyme was added after 3 h of reaction. The reaction was performed at 37° C. for 6 hours. The mixture was then heated for 10 min at 98° C. to inactivate the enzyme. After centrifugation (2 min, 5000 g) and filtration (0.45 μm), the mixture was freeze-dried to yield the hydrolysed green coffee extract (HDGCE).

Interestingly, the inventors have found that the above mentioned “crude caffeine”, DGCE, or hydrolysed DGCE are obtainable as green coffee decaffeination side stream products (i.e. decaffeinated fractions). In other words, such antioxidative materials are obtained as by-products of industrial processes used for instance for obtaining decaffeinated coffee. This makes such materials interesting from an ecologic and economic point of view, because it is not necessary to produce them commercially “on purpose”.

The source of the LC-PUFA is not critical for the subject matter of the present invention. Any such source that is known in the art can be used.

The skilled person generally knows sources of unsaturated fatty acids. Typical sources of DHA, for example, are fish oil or oils from microorganisms, such as Cryptecodinum cohnii. EP 0 515 460, for example, discloses a method for obtaining oil rich in DHA which is present in the biomass of cultivated dinoflagellates. WO 02/072742 discloses oils rich in DHA, ARA, DHGLA and EPA. A typical source of ARA, for example, is egg lecithin or biomass of fermentation processes (Mortierella alpina), the latter may be obtained according to the process disclosed in EP 0 568 608. If very pure preparations are desired, it may be advantageous to prepare the LC-PUFA containing fat or oil synthetically. However, generally it is preferred that the LC-PUFA containing oil is selected from the group consisting of a marine oil, an oil produced by microorganisms, an oil produced by one-celled plants, an oil produced by multi-cellular plants or an oil of animal origin, or mixtures thereof.

In one embodiment of the present invention, the LC-PUFA containing oil may be selected from the group consisting of a marine oil, an oil produced by microorganisms, an oil produced by one-celled plants, an oil produced by multi-cellular plants or an oil of animal origin, or mixtures thereof; and preferably may be fish oil.

The composition can be any composition where it is desired to avoid or stop LC-PUFA oxidation and/or the generation of fishy odors. For example, the composition might be a medicament or a cream for topical application. Preferably, however, the composition is a food composition.

In accordance with Codex Alimentarius, the term “food” shall mean any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

The composition of the present invention may be enriched in unsaturated fatty acids, preferably in polyunsaturated fatty acids. The poly unsaturated fatty acids (PUFA) may include omega-3 fatty acids and omega-6 fatty acids. Typical examples of LC-PUFAs used in framework of the present invention include docosahexaenoic acid (DHA), arachidonic acid (ARA), linoleic acid, alpha-linolenic acid, eicosapentaenoic acid and/or erucic acid.

In a particular preferred embodiment of the present invention, the composition may be enriched in long chain poly unsaturated fatty acids. PUFAs are considered LC-PUFAs, if the carbon chain comprises 18 C-atoms or more.

The composition in accordance with the present invention may be enriched in poly unsaturated fatty acids, preferably in long chain poly unsaturated fatty acids, even more preferred in C18, C20 and/or C22 ω-6 polyunsaturated fatty acids. Hence, the composition of the present invention may be enriched in C18, C20 and/or C22 omega-6 polyunsaturated fatty acids. The weight ratio of omega-6 fatty acids and omega-3 fatty acids in the composition of the present invention is preferably between 1:2 to 8:1, more preferably between 4:1 to 8:1.

The polyunsaturated fatty acids may at least partially be present in form of free fatty acids. They may also at least partially be present in a mono-, di- and/or triglyceride form. This glyceridic form contributes to the stability of the PUFA and, hence, helps to avoid the generation of fishy odor.

It may also be advantageous, if the composition of the present invention further comprises at least one other antioxidant. The type of antioxidant is not critical, however, in case the composition is a food product or a medicament, a food grade antioxidant is required. In cases where the composition is a product for topical administration, a food grade antioxidant is at least strongly preferred. Antioxidants may help in concert with green coffee extract to avoid that LC-PUFAs are oxidized, which likely will lead to a loss of product value. As antioxidant with particular beneficial properties in terms of avoiding fish odor generation extracts of citrus fruits, in particular lemons, can be mentioned. Further examples of suitable antioxidants may be selected from the group consisting of ascorbic acid; glutathione; lipoic acid; uric acid; carotenoids, e.g., lycopene, carotene; tocopherols; ubiquinone; hydrochinone; polyphenolic antioxidants, e.g., resveratrol, flavonoids; ascorbylpalmitate; galates; BHA; BHT; TBHQ; sulfites; retinols; carotenoides; flavonoids; tea extracts; rosemary extracts; nitrites; EDTA, citric acid, phytic acid; derivatives and/or mixtures thereof.

The amount of additional antioxidants that can be used in the framework of the present invention is not particularly limited and will depend on the type of antioxidant used and on the amount of green coffee extract and LC-PUFA present in the composition, for example. Those skilled in the art will be able to determine appropriate amounts. However, generally it is preferred if the at least one other antioxidant is added to the composition in an amount of about 0.001 weight-% to 1% weight-%, preferably of about 0.01 weight-% to 0.5 weight-% with respect to the total composition.

Hence, the composition in accordance with the present invention may further comprise an antioxidant, for example selected from the group consisting of ascorbic acid; glutathione; lipoic acid; uric acid; carotenoids, e.g., lycopene, carotene; tocopherols; ubiquinone; hydrochinone; polyphenolic antioxidants, e.g., resveratrol, flavonoids; ascorbylpalmitate; galates; BHA; BHT; TBHQ; sulfites; retinols; carotenoides; flavonoids; tea extracts; rosemary extracts; nitrites; EDTA, citric acid, phytic acid; derivatives and/or mixtures thereof. The antioxidant may be added to the composition in an amount of about 0.001 weight-% to 1% weight-%, preferably in an amount of about 0.01 weight-% to 0.5 weight-%.

In case the composition is not a raw material but a premix or product ready for consumption it may often also further comprise a carbohydrate source, a protein source, and/or a further fat source.

Hence, the composition of the present invention may be a food composition, optionally further comprising a carbohydrate source, and a protein source.

The final product may comprise an amount of LC-PUFA that corresponds to the intended purpose of the product. A typical food composition may, however comprise, in percent by weight, 0.01-0.5%, preferably 0.015-0.4%, most preferably 0.02-0.2%, for example 0.06% of LC-PUFAs.

A person skilled in the art can adjust the amount of green coffee extract appropriately in order to achieve the desired degree of LC-PUFA protection against oxidation.

For example, the weight ratio of green coffee extract to LC-PUFA may be at least about 1:200, at least about 1:150, or at least about 1:100. Excellent results are obtained, for example, if the weight ratio of green coffee extract to LC-PUFA is between about 1:10 and 1:4.

If the green coffee extract is crude caffeine, the weight ratio of green coffee extract to LC-PUFA may be at least about 1:100; preferably at least about 1:80, more preferably between about 1:8 and 1:4.

If the green coffee extract is DGCE, the weight ratio of green coffee extract to LC-PUFA may be at least about 1:200; preferably at least about 1:80, more preferably between about 1:10 and 1:8.

If the green coffee extract is Hydrolysed DGCE, the weight ratio of green coffee extract to LC-PUFA may be at least about 1:20; preferably at least about 1:10, more preferably between about 1:8 and 1:4.

If the product is a nutritional composition, it may comprise other constituents, such as macro- and micronutrients, functional food ingredients, for example. It may comprise further lipids. Typical lipid sources that may be used include milk fat, safflower oil, egg yolk lipid, canola oil, olive oil, coconut oil, palm oil, palm kernel oil, palm olein, soybean oil, sunflower oil. Medium chain triglycerides (MCT), which are defined herein as triglycerides comprising fatty acids with acyl chains of 6-12 carbon atoms (C6-C12) may also be included.

Generally, fatty acids are preferably present in the form of triglycerides. They may, however, also be present in the form of free fatty acids, esters of other alcohols than glycerol or in the form of phospholipids. Hence, in the composition of the present invention the polyunsaturated fatty acids may be at least partially present in mono-, di- and/or triglyceride form.

In a final nutritional composition the lipids may provide 30-50%, preferably 35-45% of the total energy of the nutritional composition.

As protein or carbohydrate source, generally any protein source and/or carbohydrate source suitable as ingredients in nutritional compositions may be used.

The dietary protein, which may be used may be any suitable dietary protein; for example animal proteins (such as milk proteins, meat proteins and egg proteins); vegetable proteins (such as soy protein, wheat protein, rice protein, and pea protein); mixtures of free amino acids; or combinations thereof. Milk proteins such as casein and whey protein are particularly preferred. The protein may be intact, hydrolysed protein, partially hydrolysed protein, free amino acids or a mixture of these. The protein source preferably provides from about 7 to 25% of the energy of the composition, more preferably 7-15%, most preferably 8-13%.

If the nutritional composition includes a carbohydrate source, any carbohydrates suitable for use in nutritional compositions may be used, for example digestible carbohydrates, such as maltodextrin, maltose, sucrose, lactose, glucose, fructose, corn syrup, corn syrup solids, rice syrup solids, starch, such as cereal starch, rice starch, corn starch, and mixtures thereof. The carbohydrate source preferably provides about 30% to about 70%, preferably 40-60% of the energy of the nutritional composition, for example, if it is a complete nutritional composition.

Dietary fibre (non-digestible carbohydrates) may also be present in a nutritional composition according to the present invention if desired. Numerous types of dietary fibre are available. For example, oligosaccharides, such as fructo-oligo-saccharides, galactooligosaccharides, xylo-oligosaccharides, fuco-oligosaccharides, manno-oligosaccharides, just to mention a few, may be added.

The composition may comprise further ingredients, which are designed to meet the nutritional needs of the particular human being or provide further benefits or functionalities. For example, the composition is preferably “nutritionally complete”, that is it contains adequate nutrients to sustain healthy human life for extended periods. Preferably, the composition comprises vitamins and minerals. Also trace elements may be supplied.

If necessary, the product may contain emulsifiers and stabilizers such as citric acid esters of mono-and di-glycerides. The emulsifier may be selected from the group consisting of mono- and di-glycerides, acetic acid esters of mono/di-glycerides, lactic acid esters of mono/di-glycerides, diacetyl tartaric acid esters of mono/di-glycerides, succinic acid esters of mono glycerides, sorbitan esters, sucrose esters, polyglycerol esters, calcium stearoyl lactate and mixtures thereof.

The product may optionally contain other substances, which have a beneficial effect, such as lactoferrin, nucleotides and/or nucleosides.

A nutritional composition may further comprise a probiotic microorganism, preferably selected from the geni Bifidobacterium, Lactobacillus, Strepotococcus, and mixtures of these.

The higher the content of LC-PUFA in a composition, the more a protection against unwanted fishy odor generation is needed. Of course, depending on whether the composition is a raw material, a pre-mix, a nutritional supplement, a food composition for special purposes of a general food composition, the LC-PUFA content will vary greatly, and the subject matter of the present invention can be used for all these purposes. Typically, however, in the composition in accordance with the present invention, the long chain poly unsaturated fatty acids may represent about 1-75 weight-% of the composition, preferably about 3-50 weight-% of the composition, most preferred about 5-35 weight-% of the composition.

The subject matter of the present invention also comprises products comprising the composition of the present invention. The product may be a food product for example. The product may be a LC-PUFA containing raw material, in particular a marine oil, an oil produced by microorganisms, an oil produced by one-celled plants, an oil produced by multi-cellular plants or an oil of animal origin, a nutritional complete formula, a dairy product, a chilled or shelf stable beverage, a mineral or purified water, a liquid drink, a soup, a dietary supplement, a meal replacement, a nutritional bar, a confectionery, a milk or a fermented milk product, a yoghurt, a milk based powder, an enteral nutrition product, an infant formula, an infant nutritional product, a cereal product or a fermented cereal based product, an ice-cream, a chocolate, coffee, a culinary product such as mayonnaise, tomato puree or salad dressings, a health care product, a cosmetic product, a pharmaceutical product, or a pet food.

The subject matter of the present invention also extends to the use of a green coffee extract in compositions comprising an LC-PU FA containing oil to at least partially prevent, reduce, inhibit and/or stop the oxidation of LC-PUFA in a composition.

The subject matter of the present invention further extends to the use of a green coffee extract to at least partially prevent, inhibit and/or stop the formation of fishy odors; for example to at least partially prevent, inhibit and/or stop the formation of fishy odors by at least partially preventing, reducing, inhibiting and/or stopping the oxidation of LC-PUFA in a composition.

For these uses of the present invention, the green coffee extract may be used in the composition in a weight ratio of green coffee extract to LC-PUFA of at least about 1:200, at least about 1:150, or at least about 1:100, more preferably between about 1:10 and 1:4.

The composition may be the composition described in the present invention. Similarly, green coffee extract may be used as described for the composition of the present invention.

Those skilled in the art will understand that they can freely combine all features of the present invention disclosed herein. In particular, features described for the composition or the product of the present invention may be combined with the use of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### EXAMPLES

1) Materials:

Crude caffeine was produced by a Nestle Factory at Trian (Vietnam).

Decaffeinated green coffee extracted was purchased from Chemical Resources (India) or from TESTA (Italy). The decaffeination was performed by extraction with dichloromethane (CH2Cl2). Another decaffeinated green coffee extract was purchased from Martin Bauer (Germany), and the decaffeination was performed by super critical CO2.

The enzyme (esterase from Lactobacillus johnsonii) was produced internally by over-expression in a food grade E. coli.

Refined high DHA tuna fish oils (Sofinol S.A., Manno TI, Switzerland) without extra antioxidants added was used as fish oil matrix to mix with different antioxidants to study their antioxidant capacities.

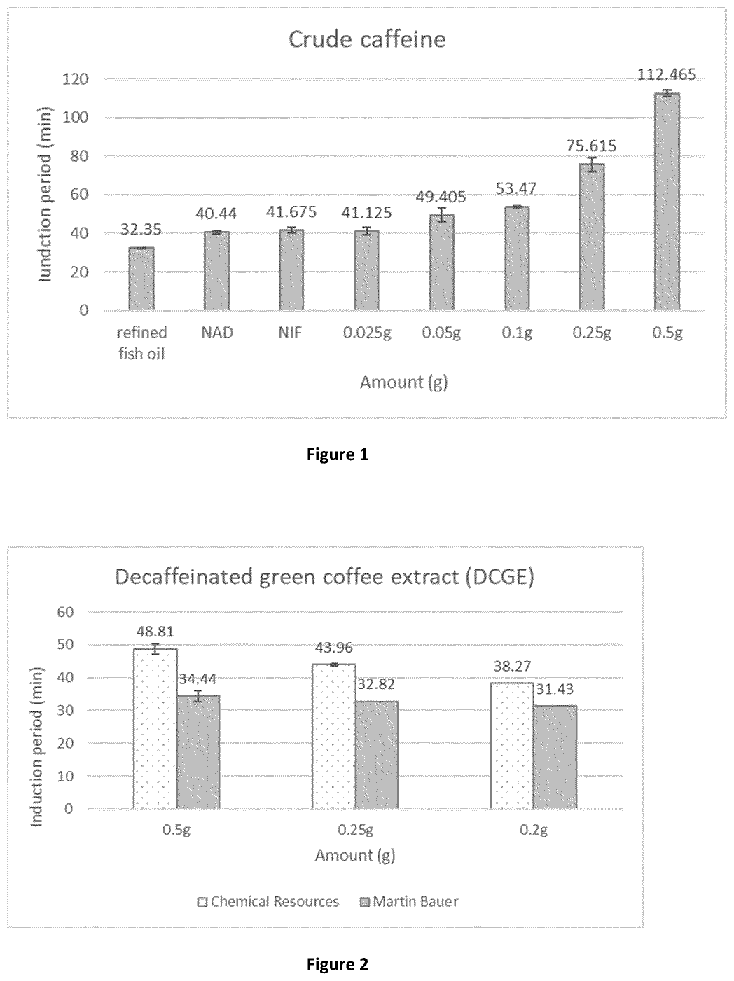

High DHA LC-PUFAs Type NIF (tuna) fish oils (Sofinol S.A., Manno TI, Switzerland) stabilized by 1500 ppm delta-rich tocopherol concentrate was used as positive control 1 (FIG. 1).

High EPA LC-PUFAs Type NAD fish oil (from Sardine, anchovy and other blue fishes, Sofinol S.A., Manno TI, Switzerland) stabilized by 1500 ppm mixed Tocopherols concentrate (d-delta Tocopherol 70%) and 200 ppm Ascorbyl Palmitate was used as positive control 2 (FIG. 1).

2) Methods:

RapidOxy 100 (Anton Paar Switzerland AG, Buchs, Switzerland) measures the induction period (IP) of a sample, under accelerated oxidation conditions: increased temperature and excessive pure oxygen.

Samples containing 2 g fish oil and vary amount of green coffee extracts were prepared in glass dishes and homogenized by hand mixing. The glass dish was then put in a stainless-steel test chamber that is charged with oxygen to a defined pressure (700 kPa) at a starting temperature of 25° C. The measurement begins by heating the test chamber to the defined target temperature (120° C.) and last until the break point was reached, which was a pressure drop of a defined percentage (e.g. 10%) below the maximum pressure of the test run.

The induction period (IP), which can be used as a measure of the oxidation stability, is specified as the time elapsed between starting the heating procedure of the test chamber and the break point (Pmax minus defined percentage), which was measured in minutes. The longer the IP, the slower the oxygen uptake, therefore, the stronger the antioxidant capacity, and vice versa.

3) Results

Crude caffeine showed concentration dependent antioxidant capacity in protecting fish oil oxidation in a mixture containing refined fish oil and crude caffeine (FIG. 1). A mixture containing 25 mg crude caffeine (1:80 w/w in fish oil) and 2 g fish oil showed similar induction period (41 min) compared to the commercially available NIF and NAD oils (40 and 41 min, respectively) which are the positive controls containing high DHA/EPA LC-PUFA and antioxidants. The IP (32 min) of the negative control, the refined high DHA LC-PUFA oil without additional added antioxidants was also shown in FIG. 1. Depending on the solvent and process used for decaffeination, decaffeinated green coffee extracts (DCGE) showed less strong or entirely loss of antioxidant capacity in protecting fish oil oxidation in a mixture containing refined fish oil and decaffeinated green coffee extracts (FIG. 2). DCGE from Chemical Resource with dichloromethane as decaffeination solvent showed stronger antioxidant capacity than DCGE from Martin Bauer where supercritical extraction using carbon dioxide (CO2) was used for decaffeination. A mixture containing 0.25 g DCGE from Chemical Resource (1:4 w/w in fish oil) and 2 g fish oil showed similar induction period (44 min) compared to the commercially available NIF and NAD oils (40 and 41 min, respectively). Because dichloromethane is a polar solvent with a polarity index of 3.1, and the non-polar plant active components can be retained in the DCGE and react as antioxidants. Whereas, these antioxidants are removed during decaffeination by supercritical extraction using carbon dioxide (CO2).

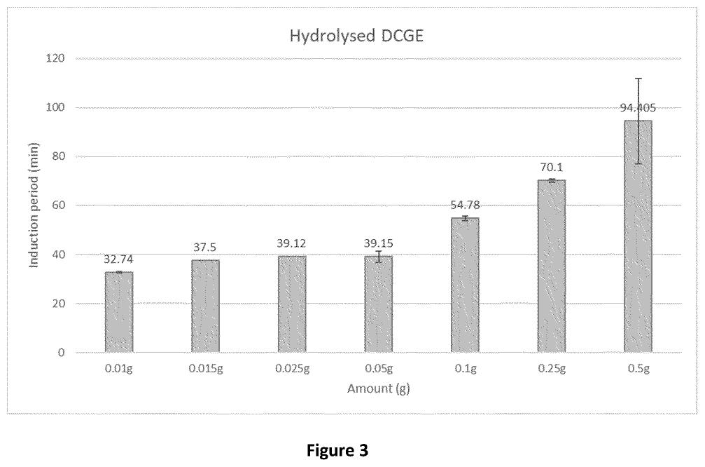

Hydrolysed decaffeinated green coffee extract (DCGE) showed again strong antioxidant capacity in protecting fish oil oxidation in a mixture containing refined fish oil and hydrolysed DCGE (FIG. 3). A mixture containing 25 mg hydrolysed DCGE (1:80 w/w in fish oil) and 2 g fish oil showed similar induction period (39 min) compared to the commercially available NIF and NAD oils (40 and 41 min, respectively).

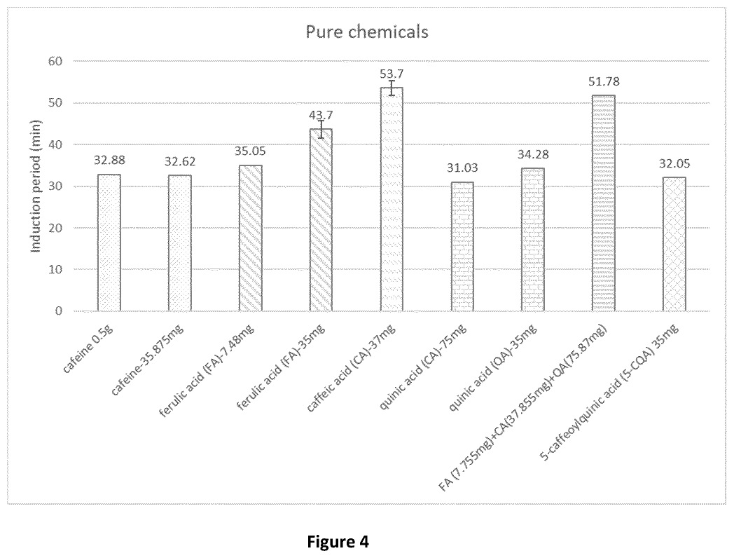

Crude caffeine is rich in caffeine and coffee polyphenols such as chlorogenic acids. DCGE is mainly composed of coffee polyphenols such as chlorogenic acids (i.e. caffeoylquinic acid). Hydrolysed DCGE contains high concentration of phenolic acids (i.e., caffeic acid, ferulic acid, quinic acid) produced by the hydrolysis of chlorogenic acids. The suspected antioxidants effects of phenolic acids are shown in protecting fish oil oxidation in a mixture containing refined fish oil and phenolic acids (FIG. 4). In comparison with the negative and positive controls, caffeic acid (37 mg) and ferulic acid (35 mg) showed stronger antioxidant effect than the positive control NIF and NAD oils. Ferulic acid showed concentration dependent antioxidant effect with less strong antioxidant effect was found at a concentration of 7.5 mg in 2 g fish oil, The combination of ferulic acid (7.7 mg), caffeic acid (37.8 mg) and quinic acid (78.8 mg) didn't improve the antioxidant capacity compare to caffeic acid alone, which demonstrated that caffeic acid may play the most important role in protecting LC-PUFA from oxidation. No antioxidant effect was observed for caffeine, quinic acid, and 5-caffeoylquinic acid at studied concentrations.

1. A food composition comprising at least one LC-PUFA containing oil and green coffee extract, wherein the composition contains at least 0.01 weight-% LC-PUFA and wherein said green coffee extract is selected from the group consisting of:
a) crude caffeine containing from 40% to 60% caffeine by weight of the green coffee extract, and containing 20% to 40% chlorogenic acid by weight of the green coffee extract, the weight ratio of said crude caffeine to LC-PUFA being at least 1:100,
b) decaffeinated green coffee extract (DGCE) containing 1% to 10% caffeine by weight of the green coffee extract, and 30% to 60% chlorogenic acid by weight of the green coffee extract, the weight ratio of DGCE to LC-PUFA being at least 1:200; and
c) hydrolysed DGCE containing 1% to 10% caffeine by weight of the green coffee extract, 1% to 10% chlorogenic acid by weight of the green coffee extract, 5% to 15% caffeic acid by weight of the green coffee extract and 0.5% to 5% ferulic acid by weight of the green coffee extract, the weight ratio of hydrolysed DGCE to LC-PUFA being at least 1:20.

2. Composition in accordance with the preceding claim 1, wherein the green coffee extract is obtained from green coffee beans by a process comprising the steps of:
a. combining green coffee beans and water in a weight ratio in the range of about 1:5 to 1:3;
b. heating the mixture to a temperature in the range of about 50-100° C. for a time period of about 200-400 minutes; and
c. collecting the extract.

3. Composition in accordance with claim 1, wherein the LC-PUFA containing oil is selected from the group consisting of a marine oil, an oil produced by microorganisms, an oil produced by one-celled plants, an oil produced by multi-cellular plants an oil of animal origin, and mixtures thereof.

4. Composition in accordance with claim 1, wherein the composition is a food composition.

5. Composition in accordance with claim 1, wherein the composition is enriched in poly unsaturated fatty acids, preferably in long chain poly unsaturated fatty acids.

6. Composition in accordance with claim 1, wherein the polyunsaturated fatty acids are at least partially present in mono-, di- and/or triglyceride form.

7. Composition in accordance with claim 1, further comprising at least one other antioxidant.

8. Composition in accordance with claim 1, wherein the long chain poly unsaturated fatty acids represent about 1-75 weight-% of the composition.

9. Product comprising a composition comprising at least one LC-PUFA containing oil and green coffee extract, wherein the composition contains at least 0.01 weight-% LC-PUFA and wherein said green coffee extract is selected from the group consisting of:
a) crude caffeine containing from 40% to 60% caffeine by weight of the green coffee extract, and containing 20% to 40% chlorogenic acid by weight of the green coffee extract, the weight ratio of said crude caffeine to LC-PUFA being at least 1:100,
b) decaffeinated green coffee extract (DGCE) containing 1% to 10% caffeine by weight of the green coffee extract, and 30% to 60% chlorogenic acid by weight of the green coffee extract, the weight ratio of DGCE to LC-PUFA being at least 1:200; and
c) hydrolysed DGCE containing 1% to 10% caffeine by weight of the green coffee extract, 1% to 10% chlorogenic acid by weight of the green coffee extract, 5% to 15% caffeic acid by weight of the green coffee extract and 0.5% to 5% ferulic acid by weight of the green coffee extract, the weight ratio of hydrolysed DGCE to LC-PUFA being at least 1:20, wherein the product is a LC-PUFA containing raw material.

10-12. (canceled)
